(19) United States
(12) Patent Application Publication
(10) Pub. No.: US 2024/0190161 A1
(43) Pub. Date: Jun. 13, 2024

(54) METHOD FOR UNIQUE MARKING AND IDENTIFICATION OF PRODUCTS

(71) Applicant: FRAUNHOFFER-GESELLSCHAFT ZUR FÖRDERUNG DER ANGEWANDTEN FORSCHUNG E. V., München (DE)

(72) Inventors: Tobias Jochum, Hamburg (DE); Waldemar Berchtold, Darmstadt (DE); Jan Niehaus, Hamburg (DE); Bert Fischer, Potsdam (DE); Christopher Krauss, Berlin (DE); Stephan Steglich, Berlin (DE); Martin Steinebach, Darmstadt (DE); Armin Wedel, Potsdam (DE)

(21) Appl. No.: 18/286,253

(22) PCT Filed: Apr. 11, 2022
(86) PCT No.: PCT/EP2022/059620

§ 371 Date: Oct. 10, 2023

(30) Foreign Application Priority Data
Apr. 15, 2021 (DE) 102021109455.0

(51) Int. Cl. B42D 25/378; B42D 25/382; G07D 7/1205; G07D 7/2033

(52) U.S. Cl. CPC B42D 25/378; B42D 25/382; G07D 7/1205; G07D 7/2033; G07D 2207/00

(57) ABSTRACT

The present invention relates to a method for unique marking and to a method for the identification of products by identifying production inaccuracies in the spectral range of up to 3000 nm and to the use of said method for the unique identification of products/documents in serialization systems and/or track and trace systems and for document authentication. In order to increase the number of production inaccuracies up to a spectral range of up to 3000 nm, photoluminescent materials which, under photon excitation, emit radiation in the range of up to 3000 nm, preferably in the range of 750 to 1800 nm, most preferably in the range of 800 to 1100 nm, can be used. Said photoluminescent materials make it possible for production inaccuracies to be sensed from the spectral range of visible light (380 to 750 nm), via the near-infrared (NIR) range, to a spectral range of up to 3000 nm.

The present invention relates to a method for unique marking and identification of products through identification of production inaccuracies in the spectral range of up to 3000 nm.

### PRIOR ART

Product counterfeiting causes worldwide economic losses of several billion US dollars. In Europe alone, product counterfeiting causes an economic loss of more than 80 billion euros. The range of counterfeit products is vast. There is increasing counterfeiting of cosmetics, watches, tobacco products, and medical products. In 2019, the pharmaceutical and tobacco industry-pursuant to EU Directives (2011/62/EU and 2014/40 EU) introduced a serialisation system for the monitoring of their products. Product protection can only be ensured by means of a unique and secure identity via and end-to-end system (from the manufacturer to the end user).

A variety of technologies have become established worldwide in the battle against product counterfeiting, offering different solution approaches.

Solution approaches from serialisation and track and trace technology should be mentioned as dominating the market. These approaches are used in order to detect the unique tracking and tracing of process steps in the production chain. Moreover, (further) product information can also be transferred by this method. Information storage devices/media are required for this purpose. The main information storage devices are radio frequency identifiers (RFID) or bar codes. In the former case, communication takes place via electromagnetic waves, and in the latter, via light waves. Bar codes are generally widespread, as they can be simply produced and read by anyone. A distinction is made among the one-dimensional bar code (semicolon), the two-dimensional bar code (QR code), the three-dimensional bar code (coloured bar code) and the four-dimensional bar code (coloured bar code that changes over time and is shown on a display).

In serialisation and tracking and tracing, each product is given an identity. One distinguishes three types of identities.
Identity (ID): used for the identification of articles or manufacturers (classes of entities), e.g.: QR code;
Unique identity: used for the identification of individual entities, e.g.: QR code with individual serial number;
Secure and unique identity: used for the identification and authentication of entities, for example a QR code with a second factor that is inseparably bound to the identity, such as e.g. a physical feature of the entity.

Current tracking and tracing technologies show a unique identity based on bar codes. Bar codes are generally easy to copy and transfer. Expansion to include a secure identity solves the problem of easy copiability. This requires the addition of a second factor that serves as a security anchor. This security anchor is often implemented in the form of a physically unclonable function (PUF) in combination with encryption by cryptographic methods. Production inaccuracies are an example of PUF functions. The problem in globally interconnected supply chains is the large number of products. For a secure and unique identity, each product must have an unmistakable PUF. In the prior art, production and/or printing inaccuracies have been evaluated and detected by commercial camera systems in the range of visible light (400-750 nm). The greater the number of products to be securely and unequivocally differentiated by means of PUF functions, the greater this requires either the resolution of the recording device or the printing surface to be so that each product receives a unique arrangement of production inaccuracies. With a number of products in the range of several million, the printed flat element would therefore have to be 10 cm² or larger in order to detect only deviations in the visible wavelength range with a commercial smartphone—at a distance of 10-30 cm from the camera to the substrate.

The present invention describes a unique identity suitable for marking and identification of products and for document security with which a plurality of products and/or documents in quantities in the range of several million can be marked and identified on an acceptable flat element. The unique identity is obtained by extracting production inaccuracies after printing of an identification pattern on at least one surface of the product or document to be marked. A sufficient number of production inaccuracies for unique identification of an individual entity of a product/document in a plurality of products/documents in the range of up to several million entities is ensured by the detection of production inaccuracies over a range of up to 3000 nm. In order to increase the number of production inaccuracies up to a spectral range of up to 3000 nm, photoluminescent materials can be applied to at least one surface of the product or document to be marked which emit radiation under photon excitation in the range of up to 3000 nm, preferably from 750 to 1800 nm, and most preferably from 800 nm to 1100 nm. These photoluminescent materials make it possible to detect production inaccuracies in the spectral range of visible light (380 nm to 750 nm) via the near-infrared (NIR) range of up to a spectral range of up to 3000 nm. This expansion, because of the higher density of production inaccuracies per area, allows a reduction of the area in the range in which the identification pattern can be read out and stored using corresponding software by simple electronic and mobile smart devices, for example smartphones and tablets.

### SUBJECT MATTER OF THE INVENTION

The present invention relates to a method for unique marking of products/documents, which comprises the following steps:
attaching a flat element to at least one surface of the product;
irradiating the attached flat element with photons;
extraction of production inaccuracies from the attached flat element in the range of up to 3000 nm, preferably up to 1800 nm, more preferably up to 1400 nm, and most preferably up to 1100 nm;
storage of the production inaccuracies extracted from the attached flat element.

The invention further relates to a method for identifying products/documents that have been marked by the method for unique marking as described herein, wherein the method comprises the following steps:
irradiating the attached flat element with photons;
extraction of production inaccuracies from the attached flat element in the range of up to 3000 nm, preferably up to 1800 nm, more preferably up to 1400 nm, and most preferably up to 1100 nm;
correlating of the extracted production inaccuracies with the stored production inaccuracies.

The invention also relates to a product with an optical security feature for unique marking and identification, preferably for unique and secure marking and identification, of products on at least one flat element of the surface of the product, wherein the security feature comprises an attached flat element, wherein the attached flat element comprises production inaccuracies that are preferably extracted in the range of up to PUFF 3000 nm, preferably up to 1800 nm, more preferably up to 1400 nm, and most preferably up to 1100 nm.

The invention further relates to use of the optical security feature as described herein as a unique identity, preferably as a unique and secure identity, for product authentication and/or for document authentication.

Moreover, the invention relates to a serialisation and/or track and trace system that comprises an optical security feature as described herein.

Finally, the invention relates to use of an optical security feature as described herein in a serialisation and/or track and trace system and/or for document authentication.

### Definitions

The term “unique marking” within the meaning of the present invention means that a sufficient number of individual markings is available in order to individually identify each entity of a group of products to be marked. Each individual marking differs from the other individual markings in at least one feature. For example, for a group of a total of 1 million products, at least 1 million individual markings must be available that differ from one another in at least one feature.

The term “secure and unique marking” within the meaning of the present invention comprises unique and unmistakable marking by means of a unique marking as defined above (for example a unique serial number that is integrated into the product or document as inseparably as possible, for example by evaluating production inaccuracies), which is secured by cryptographic methods (for example a digital seal), so that on transferral to another document, verification (checking/reading) of the marking fails.

The term “products” within the meaning of the present invention comprises the products themselves, to the extent that they are capable of marking, their packagings, product labels (tags), bar code cards and bar code labels, and all other possibilities by means of which a product has ordinarily been marked during the production process and/or transport. Products comprise products and their intermediate stages, commercial goods and documents. Some examples of products and their intermediate stages or commercial goods are as follows: a name-brand product, a consumer product, a pharmaceutical product, a health product, a food product, a component, a hardware component, an electronic component, a computer chip, a book, a manual.

The term “documents” within the meaning of the present invention as a subunit of the term “products” comprises natural, cellulose-based substrates, artificial polymer-based substrates and mixtures thereof, in particular bank notes, ID cards, passports, birth certificates, driving licenses, entry tickets and other tickets. A few further examples are as follows: a check, a bond, a bank card, a credit card, a check card, a currency, a cash card, an identifying object, an identity object, an entrance object, an object for issuing a permit, a personal ID card, a social insurance certificate, a driving license, a vaccination certificate, a test certificate, a health card, an insurance card, a personalised object, a passport, a document, a paper document, a security document, a stamp, a personalised document, an ad hoc document, a certificate, a share certificate, a debt certificate, a contract, an insurance policy, a will, a parking ticket, a transportation ticket, or a ticket for admission to an event.

The term “printing composition” within the meaning of the present invention comprises any desired composition that can be used for example as an ink formulation or toner in the printing methods specified below. The printing composition may be a liquid printing composition, such as e.g. an ink formulation, or a solid or powdered printing composition, such as e.g. a toner.

The term “ink formulation” within the meaning of the present invention comprises any desired solvent and combinations thereof, as well as typical additives that are suitable for producing a printable liquid.

The term “toner” within the meaning of the present invention comprises any desired solid or powder composition and combinations thereof and typical additives that are suitable for producing a printable solid or powder.

The term “production inaccuracy” within the meaning of the present invention comprises all possible fluctuations in the production or manufacturing process of physical objects and fluctuations in printing processes such that an individual feature image arises that is bound to a physical object. Moreover, within the meaning of the present invention, the term comprises unintentional and intrinsic deviations in the examined area of the physical object relative to the examined area of identical physical objects and its original digital image. These unintentional and intrinsic deviations may be deviations in the surface of the product, document and/or substrate itself, deviations in a printed-on printing composition, or deviations in the print image of an identification patter printed on with a printing composition. Examples of deviations in the surface of the product, document and/or substrate include surface irregularities, differences in the fibre structure or fibre thickness, holes, protrusions, scratches, edge contours, granularities, roughness and haziness. Examples of deviations in the printed-on printing composition are deviations in viscosity, surface tension, or particle size, particle agglomerations, etc. Examples of deviations in the print image of the identification pattern printed on with the printing composition are printing inaccuracies and printing defects such as different line thicknesses, line paths, line widening, edge contours, satellite drops, multiple ink drops on a flat element, no ink drops, which are attributable to individual error and incorrect settings of the printer, such as e.g. lack of a printing impulse, clogging or incorrect setting of the printing nozzles or inconsistent guiding of the substrate and/or printing head. Excluded from the term “production inaccuracies” are deviations made knowingly by the manufacturer or exhibitor on the surface of the product, document and/or substrate, in the printing composition or in the print image, such as e.g. intentional manipulations of the surface of the product, document and/or substrate, for example by adding foreign bodies or incorporating cavities, additives, such as pigments, into the printing composition or targeted flaws or incorrect colours into the print image.

The term “extraction of production inaccuracies” within the meaning of the present invention comprises the measuring and evaluation of deviations from the “perfect” digital original. In reality, almost all products, documents and substrates show production inaccuracies. These may not be perceptible to the unaided human eye, thus often requiring optical measuring devices such as such as e.g. a spectrometer, camera or smart devices.

In cases where deviations can be measured by imaging with an optical measuring device, such as e.g. a spectrometer, camera or smart devices, the present invention refers to this as a production inaccuracy.

Within the meaning of the present invention, the term “printing” comprises the deposition of pigments on or in a solid substrate. Typical examples include, but are not limited to, offset printing, digital printing, ink-jet printing, screen printing, transfer printing, stamp printing, roll to roll, contactless printing, laser printing, spray printing, spray processes, thermal printing, thermal transfer printing, and other methods.

Photoluminescence refers to the emission of photons following prior excitation by means of photons of higher energy, mostly in the ultraviolet but also in the visible range. The excitation raises an electron to a higher energy state. When it falls back to a lower energy state, this energy is again given off in the form of photons. In a luminescent substance, a rough distinction is made between two types of excitation: in fluorescence, the electron falls from a higher singlet state back to the lower energy state, while in phosphorescence, the excited electron transitions into an elevated triplet state, which is prohibited by spin selection rules, from which it again falls back to the lower energy state, which is also prohibited by spin selection rules.

### FIGURES

FIGS. 1 and 2 show examples of individual printing inaccuracies or printing defects of an individual printer as an example of production inaccuracies that can be used as an individual and unique pattern as physically unclonable functions (PUF) for unique identities.

### DETAILED DESCRIPTION OF THE INVENTION

### Marking of a Product:

The present invention relates to a method for unique marking of products/documents, which comprises the following steps:
attaching a flat element to at least one surface of the product;
irradiating the attached flat element with photons;
extraction of production inaccuracies from the attached flat element in the range of up to 3000 nm, preferably up to 1800 nm, more preferably up to 1400 nm, and most preferably up to 1100 nm;
storage of the production inaccuracies extracted from the attached flat element.

In a first step, a flat element is attached to at least one surface of the product to be marked.

This attached flat element may be a flat element on any type of surface that is associated with the product, such as e.g. directly at least one flat element of the surface of the product, provided the concrete properties of the product allow this, at least one flat element of the surface of the packaging of the product, at least one flat element of a label, tag, bar code card and/or bar code label, with which the surface of the product is glued or labelled, or combinations thereof (for example a part of the surface of the product or packaging of the product combined with at least one part of the flat element of a label, tag, bar code card and/or bar code label).

Preferably, the same flat element is attached to the at least one surface of the product for each entity of the number of products to be marked.

The attached flat element may include one or more patterns, such as e.g. flat elements, stripes, lines, geometric figures such as circles, triangles, rectangles, polygons, etc. alphanumeric characters, characters, pictures or combinations thereof.

The minimum size of the attached flat element depends on the number of the entities of a product to be characterised. The large the number of entities, the larger the minimum size of the attached flat element. The attached flat element must be selected with a size sufficiently large that the number of extracted production inaccuracies is sufficient to individualize each entity.

Ordinarily the attached flat element has a size of less than 10 cm².

The attached flat element is irradiated with photons, preferably with white or blue light.

An example of a light source is a halogen lamp or LED lamp, preferably a blue or white LED lamp. Another suitable light source for the irradiation is an LED flash, such as e.g. the LED flash of a terminal device, such as e.g. a smartphone or tablet.

In a specific embodiment, the photons may also comprise shorter-wavelength light such as UV light. A suitable light source for this embodiment is a UV lamp.

During and/or after irradiation, the attached flat element is examined for production inaccuracies in the spectral range of up to 3000 nm, preferably up to 1800 nm, more preferably up to 1400 nm, and most preferably 1100 nm. These production inaccuracies are extracted from the attached flat element.

The lower limit of the spectral range is ordinarily at 380 nm, preferably at 390 nm, and most preferably at 400 nm.

As not all of the spectral range lies in the visible light range, for this step an electronic device is also required that can detect the emitted irradiation over the entire spectral range of up to 3000 nm, preferably up to 1800 nm, more preferably up to 1400 nm, and most preferably up to 1100 nm.

Examples of suitable devices include spectrometers, industrial cameras, NIR cameras, but also smart devices such as smartphones or tablets, which in their camera systems have a silicon-based image sensor that can detect incident photons up to a wavelength of approx. 1100 nm.

However, detection can be carried out using corresponding software, for example an app.

It is preferred that the irradiation of the attached flat element with photons and the extraction of production inaccuracies from the attached flat element take place using the same electronic device and corresponding software, such as e.g. an electronic smart device, such as e.g. a smartphone or tablet with suitable software, for example an app. In a special embodiment, production inaccuracies can be extracted from the attached flat element in a spectral range of at least 200 nm, preferably at least 225 nm, and more preferably at least 250 nm as a lower limit. Special electronic detectors are required for this purpose, such as e.g. UV detectors.

The attached flat element preferably comprises photoluminescent materials that emit radiation under photon excitation in the range of up to 3000 nm, preferably up to 1800 nm, more preferably up to 1400 nm, and most preferably up to 1100 nm.

These photoluminescent materials are preferably comprised in one or more printing composition(s).

These printing composition(s) can be printed onto at least one surface of the product, preferably in the form of an identification pattern.

In this embodiment described here, the method according to the invention preferably comprises the following further steps in the area of “marking of a product”:
Preparation of one or more printing composition(s) that comprise one or more photoluminescent materials which emit radiation under photon excitation in the range of up to 3000 nm, preferably up to 1800 nm, more preferably up to 1400 nm, and most preferably up to 1100 nm;
printing of the printing composition(s) onto at least one flat element of the surface of the product in the form of an identification pattern.

One or more printing composition(s), such as e.g. ink formulation(s) or toners, is/are preferably prepared, which comprise one or more photoluminescent materials that emit radiation under photon excitation in the range of up to 3000 nm, preferably up to 1800 nm, more preferably up to 1400 nm, and most preferably up to 1100 nm.

The printing composition(s) is/are preferably commercial printing composition(s) suitable for the deposition of pigments on or in a solid substrate. Depending on the type of printing, suitable printing compositions may be liquid printing compositions such as ink formulations or solid or powdered compositions such as toner. Typical examples include but are not limited to offset printing, digital printing, ink-jet printing, screen printing, transfer printing, stamp printing, roll to roll, contactless printing, laser printing, spray printing, spray processes, and other methods.

The printing composition may already comprise colour pigments. The result can be that the identification pattern printed with the printing composition is visible to the unaided human eye. Detection of the production inaccuracies on the product/document/package is carried out up to 3000 nm, preferably up to 1800 nm, more preferably up to 1400 nm, and most preferably up to 1100 nm, by means of electronic devices, for example spectrometers, smart devices or industrial cameras.

In another embodiment, the printing composition comprises no further colour pigments other than the photoluminescent materials that emit radiation under photon excitation in the range of 750 nm to 3000 nm, preferably from 780 nm to 1800 nm, more preferably from 800 nm to 1400 nm, and most preferably from 850 nm to 1100 nm. In this embodiment, the identification pattern printed on with the printing composition may not be visible to the unaided human eye due to concentration and print resolution effects of the printing composition. The identification pattern may therefore not be discernible immediately. Detection of the production inaccuracies on the product/document/packaging is carried out up to 3000 nm, preferably up to 1800 nm, more preferably up to 1400 nm, and most preferably up to 1100 nm by means of electronic devices as described above, for example spectrometers and smart devices.

In a third embodiment, an identification pattern is first printed with a commercial printing composition onto at least one surface of the product. In a second step, the printing composition, which comprises the photoluminescent materials that the emit radiation under photon excitation in the range of 750 nm to 3000 nm, preferably from 780 nm to 1800 nm, more preferably from 800 nm to 1400 nm, and most preferably from 850 nm to 1100 nm, is used to print a further identification pattern. In this embodiment, the printing composition according to the invention preferably comprises no pigments, so that the identification pattern might potentially not be visible to the unaided human eye. The printing composition(s) are preferably printed next to one another and thus form a layer of dots of varying dye composition that produce a pattern of the identification pattern.

In many embodiments, the printing compositions are printed on next to and optionally atop one another and thus form one and/or more layers of dots of varying dye composition that produce a pattern of the identification pattern. Detection of the production inaccuracies on the product/document/packaging is carried out up to 3000 nm, preferably up to 1800 nm, more preferably up to 1400 nm, and most preferably up to 1100 nm by means of electronic devices as described above, for example spectrometers, cameras, and smart devices.

In a fourth embodiment, the identification pattern according to one of the above embodiments is printed onto at least one label, which is then glued to at least one surface of the product.

In a fifth embodiment, the identification pattern according to one of the first three embodiments is printed onto product labels (tags), bar code cards and/or bar code labels.

In a sixth embodiment, the printing composition comprises both at least two different emitting photoluminescent materials, which under photon emit excitation radiation in the range of 750 nm to 3000 nm, preferably from 780 nm to 1800 nm, more preferably from 800 nm to 1400 nm, and most preferably from 850 nm to 1100 nm, as well as further colour pigments. In this embodiment, the identification pattern printed on with the printing composition can be perceived with the unaided human eye. Both the various emission maxima and the respective (intensity) conditions can also be stored.

In a seventh embodiment, the printing composition comprises at least two different emitting photoluminescent materials, which emit radiation under photon excitation in the range of 750 nm to 3000 nm, preferably from 780 nm to 1800 nm, more preferably from 800 nm to 1400 nm, and most preferably from 850 nm to 1100 nm, without further colour pigments. In this embodiment, the identification pattern printed on with the printing composition cannot be perceived by the unaided human eye. Both the various emission maxima and the respective (intensity) conditions can also be stored.

In the eight embodiment, the printing composition(s) comprise one or more colour pigments, which emit radiation under photon excitation in the range of 380 nm to 750 nm. The identification pattern printed on with the printing composition(s) is therefore visible to the unaided human eye. The colour pigments are preferably colour pigments that are ordinarily used in printing compositions such as commercial printing compositions. Commercial printing compositions may be used, and these may be mixed with the photoluminescent materials that emit radiation under photon excitation in the range of 750 nm to 3000 nm, preferably from 780 nm to 1800 nm, more preferably from 800 nm to 1400 nm, and most preferably from 850 nm to 1100 nm, and optionally other dyes. The printing composition(s) further comprise one or more photoluminescent materials that emit radiation under photon excitation in the range of 750 nm to 3000 nm, preferably from 780 nm to 1800 nm, more preferably from 800 nm to 1400 nm, and most preferably from 850 nm to 1100 nm.

The photoluminescent materials emit radiation under photon excitation in the range of up to 3000 nm, preferably up to 1800 nm, more preferably up to 1400 nm, and most preferably up to 1100 nm.

Photoluminescent materials are generally suitable that emit radiation under photon excitation from at least 200 nm, preferably at least 225 nm, and more preferably at least 250 nm as a lower limit.

In a preferred embodiment, the photoluminescent materials emit radiation under photon excitation from at least 380 nm, preferably from at least 390 nm, and most preferably from at least 400 nm as a lower limit.

In a particularly preferred embodiment, the photoluminescent materials emit radiation under photon excitation from at least 750 nm, preferably from at least 780 nm, more preferably from at least 800 nm, and most preferably from at least 850 nm as a lower limit.

The photoluminescent materials are preferably selected from photoluminescent dyes and semiconducting inorganic nanocrystals.

The semiconducting inorganic nanocrystals preferably emit radiation under photon excitation in the range of 750 nm to 1800 nm, more preferably from 800 nm to 1400 nm, and most preferably from 850 nm to 1100 nm.

Examples of suitable semiconducting inorganic fluorescent (core) nanocrystals include Ag₂S, Ag₂Se, Ag₂Te, CdS, CdSe, CdTe, PbS, PbSe, PbTe, SnTe, ZnS, ZnSe, ZnTe, InP, InAs, Cu₂S, In₂S₃, InSb, GaP, GaAs, GaN, InN, InGaN, ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, CuInS₂, CuInSe₂, CuInGaSe₂, CuInZnS₂, CuZnSnSe₂, CuIn(S,Se)₂, CuInZn(S,Se)₂, and AgIn(S,Se)₂.

Further suitable examples include but are not exclusively limited to perovskite materials with the general formula ABX₃ or A₄BX₆, wherein X can be selected from Cl, Br, I, O and/or mixtures thereof, wherein A can be selected from Cs, CH₃NH₃, CH(NH₂)₂, Ca, Sr, Bi, La, Ba, Mg and/or mixtures thereof, and wherein B can be selected from Pb, Sn, Sr, Ge, Mg, Ca, Bi, Ti, Mn, Fe and/or mixtures thereof.

Moreover, core/shell and/or core/multishells of semiconducting inorganic nanocrystal architectures of II-VI, III-V, IV-VI, I-VI, I-III-VI semiconductors or mixtures thereof and core/shell and/or core/multishells of perovskite materials are further suitable examples.

The crystal lattice of the semiconducting inorganic nanocrystals may additionally, but not exclusively, be doped with one or more metal ions, such as e.g. Cu+, Mg²⁺, Co²⁺, Ni²⁺, Fe²⁺, Mn²⁺ and/or with one or more rare earth metals, such as e.g. ytterbium, praseodymium or neodymium.

The semiconducting inorganic nanocrystals preferably have an average particle size of 1 nm to 100 nm, more preferably from 2 nm to 50 nm, and most preferably from 3 nm to 15 nm in at least one dimension, and preferably in all dimensions.

The average particle size can be further increased/modified by various methods. Typical examples include but are not exclusively limited to a silica shell, a titanium oxide shell, a halogen shell and further methods for increasing stability, masking, biocompatibility, water solubility and/or coating.

An interesting property of the preferred semiconducting inorganic nanocrystals is that their excitation and emission spectrum depends among other factors on their particle size.

The semiconducting inorganic nanocrystals are preferably photoluminescent substances that are brought by light absorption into electronically excited energy states, and then return to lower-energy states by emitting light in the form of fluorescence.

The printing composition(s) may also comprise, aside from and in addition to the photoluminescent semiconducting inorganic nanocrystals, one or more further photoluminescent dyes.

The photoluminescent dyes preferably emit radiation under photon excitation in the range of 380 to 1800 nm, more preferably from 450 to 1400 nm, and most preferably from 750 nm to 1100 nm.

The photoluminescent dyes may be selected from fluorescent dyes, phosphorescent dyes and mixtures thereof.

Fluorescent dyes are dyes that after photon excitation emit fluorescent radiation, while phosphorescent dyes are dyes that after photon excitation emit phosphorescent radiation.

Suitable phosphorescent dyes may show under photon excitation both a Stokes shift and an anti-Stokes shift. Moreover, phosphorescent materials can show both fluorescence and phosphorescence behaviour. The phosphorescent materials may be both organic and inorganic crystals/molecules.

Fluorescent dyes are ordinarily selected from organic fluorescent dyes and inorganic fluorescent dyes or mixtures thereof.

Organic dyes may be selected from the classes of the proteins and peptides, small organic molecules, synthetic oligomers and polymers, and multicomponent systems.

Typical examples of polymers or peptides are green fluorescent protein (GFP), yellow fluorescent protein (YFP) or red fluorescent protein (RFP).

Non-protein organic fluorescent dyes ordinarily belong to the classes of the xanthene derivatives, cyanine derivatives, squaraine derivatives, squaraine-rotaxane derivatives, naphthalene derivatives, coumarin derivatives, oxadiazole derivatives, anthracene derivatives, pyrene derivatives, pyrazine derivatives, acridine derivatives, aryl methane derivatives, tetrapyrrole derivatives and dipyrromethene derivatives. Organic fluorescent dyes are ordinarily commercially available in all emission spectrum colours from blue (ab 380 nm) to red (up to 1800 nm).

Suitable organic dyes with emission spectrum colours from 800 nm on are described for example in EP 0 933 407, U.S. Pat. Nos. 5,282,894, 5,665,151, WO 1998/018871, WO 2003/038003, U.S. Pat. Nos. 10,119,071 and 5,542,971.

Suitable inorganic dyes are preferably the above-described semiconducting inorganic nanocrystals.

Phosphorescent dyes are ordinarily selected from doped oxides, nitrides, oxynitrides, sulphides, selenides, halides, silicates and aluminates of calcium, strontium, barium, zinc, cadmium, manganese, silicon and rare earth metals and mixtures thereof. In most cases, but not exclusively, one uses sulphides of metals of group II of the periodic table and zinc and aluminates of metals of group II of the periodic table. The doping substances can for example be metals or metal salts. Suitable examples of phosphorescent dyes are doped sulphides and aluminates of calcium, strontium, barium and zinc, such as e.g. bismuth-doped calcium/strontium sulphide, copper-doped zinc sulphide, and europium-doped strontium aluminate.

Photoluminescent dyes with Stokes shift behaviour are preferably photoluminescent substances that are brought by light absorption of a higher-energy photon into electronically excited energy states, and then return to lower-energy states by emitting light in the form of fluorescence or phosphorescence.

The photoluminescent materials are preferably excited by visible light, such as blue or white light, and higher-energy NIR irradiation as the emission signal.

The photoluminescent materials emit radiation under photon excitation with a wavelength in the range of 200 nm to 3000 nm in the broadest spectral range as described above.

In a particularly preferred embodiment, the photoluminescent materials emit radiation under photon excitation with a wavelength in the range of 750 to 1800 nm, more preferably from 800 to 1400 nm, and most preferably from 850 nm to 1100 nm. These wavelength ranges are in the non-visible near infrared range (NIR range).

The content of photoluminescent materials in the printing composition is preferably 0.01 to 70.0 wt %, more preferably 0.05 to 40.0 wt %, and most preferably 0.1 to 30.0 wt %, measured based on the total weight of the printing composition. For digital and ink-jet printing, a range of between 0.01 and 30.0 wt % is to be preferred.

The printing composition may comprise photoluminescent materials that have at least one or all, preferably all of the following properties in common: emission wavelength, emission distribution, and emission maximum. In another embodiment, the range printing composition may contain mixtures of photoluminescent materials that have different values for emission wavelength, emission distribution, and emission maximum.

Moreover, the printing composition may comprise the colour pigments of commercial toners or inks. Commercial printing compositions may be used, and these may be mixed with the photoluminescent materials.

The emitted irradiation of the printing composition may yield an individual fluorescence spectrum that depends on the type, amount, and particle size of the photoluminescent materials, preferably the semiconducting inorganic nanocrystals. The individual fluorescence spectrum can be detected with a spectrometer. The detected individual fluorescence spectrum can then be compared with an already-stored reference spectrum.

In addition, this individual fluorescence spectrum can be used as a further security feature for a printing composition individually mixed by the manufacturer of the product.

The printing compositions for e.g. ink-jet printing preferably have a reciprocal Ohnesorge number of less than 14, more preferably from 1 to 10, even more preferably from 1 to 8 and most preferably from 2 to 4.

The step “printing of the printing composition(s) onto at least one flat element of the surface of the product in the form of an identification pattern” comprises both the printing of the printing composition(s) directly onto at least one flat element of the surface of the product, provided the concrete properties of the product allow this, and the printing of the printing composition(s) onto at least one label in the form of this identification pattern and gluing/labelling of the surface of the product with at least one printed label.

If the shape and/or concrete properties of the product do not allow direct marking, the step “printing of the printing composition(s) onto at least one flat element of the surface of the product in the form of an identification pattern” can also comprise the printing of the printing composition(s) directly onto at least one flat element of the surface of the packaging of the product or gluing/labelling of the surface of the product with at least one printed label.

The identification pattern may also be printed onto documents.

For this purpose, the usual printing methods can be used, depending on the type of printing compositions. Preferably, the printing compositions are printed onto at least one flat element of the surface of the product or document by means of offset printing, digital printing, ink-jet printing, screen printing, transfer printing, stamp printing, roll to roll, contactless printing, laser printing, spray printing, spray processes, thermal printing, thermal transfer printing, and further methods.

Depending on the type of product, the identification pattern can be directly printed onto the surface of the product or document, onto the packaging of the product and onto labels, tags, bar code cards and/or bar code labels.

The identification pattern ordinarily comprises flat elements, stripes, lines, geometric figures such as circles, triangles, rectangles, polygons, etc., alphanumeric characters, characters, or combinations thereof.

The identification pattern can be one- or multidimensional.

Suitable dimensions for the multidimensional identification pattern are spatial dimensions, for example in the x and/or y direction, or colour dimensions, for example the intrinsic colour of the dyes in the printing compositions and/or the various emission spectra of the semiconducting inorganic nanocrystals.

The identification pattern may be a one-dimensional pattern, such as e.g. a bar code, a two-dimensional pattern, such as e.g. a QR code, or a three-dimensional pattern, such as e.g. a coloured bar code.

The identification pattern may also comprise one or more patterns, such as e.g. flat elements, stripes, lines, geometric figures such as circles, triangles, rectangles, polygons, etc. alphanumeric characters, characters, pictures or combinations thereof.

The identification pattern for each product to be individually marked must be unique. This means that the identification pattern of each entity of the products to be marked differ in at least one feature from the identification pattern of the other entities.

The identification pattern can also contain a unique code or be a unique code. In this case, the identification pattern for each product to be individually marked is preferably unique.

For this purpose, at least one reference value, and preferably several reference values of the product can be encrypted by means of a secure key.

Possible reference values include reference values on the type and nature of the product such as serial numbers, lot numbers, CAS numbers in the case of chemical products, the place of production, time of production, place of delivery, the manufacturer, the supplier, the client or the like.

The secure key can be provided to the manufacturer or produced by the manufacturer personally.

For encryption, a unique code for the product, preferably for the individual packaging unit of the product, will be generated.

Because of the encryption using the secure key, the unique marking of the present invention can be used as a secure and unique marking.

It is preferred for the flat element attached to the surface of the product to at least partially overlap with the flat element of the printed identification pattern.

The attached flat element can be bigger, smaller, or the same size as the flat element of the printed identification pattern. The attached flat element may but does not have to be congruent with the flat element of the printed identification pattern.

The attached flat element may but not does not have to have the same shape as the identification pattern.

The attached flat element preferably overlaps at least partially with the flat element of the printed identification pattern, for example in the range of 10% to 100%, preferably from 25% to 100%, more preferably from 50% to 100%, and most preferably from 75% to 100%.

Because of this overlapping, on later extraction of production inaccuracies from the attached flat element, production inaccuracies can also be detected that result from deviations in the printed-on printing composition or deviations in the print image of the identification pattern printed on with the printing composition.

As described above, the attached flat element is irradiated with photons and the production inaccuracies are extracted.

After irradiation, the attached flat element, preferably the photoluminescent materials in the printing composition of the printed-on identification pattern, emits radiation in the range of up to 3000 nm, preferably up to 1800 nm, more preferably up to 1400 nm, and most preferably up to 1100 nm, and more preferably the semiconducting inorganic nanocrystals in the printing composition of the printed-on identification pattern emit radiation in the range of 750 to 1800 nm, preferably from 800 to 1400 nm, and most preferably from 850 nm to 1100 nm.

Irradiation in the range from 750 nm, such as e.g. from 750 nm to 1800 nm (NIR irradiation), cannot be perceived by the unaided human eye. Instead, an electronic device is required for detection that can detect the emitted irradiation over the entire range of up to 3000 nm, for example from 750 to 1800 nm, preferably from 800 to 1400 nm, and most preferably from 850 nm to 1100 nm.

For example, suitable devices are spectrometers, industrial cameras, NIR cameras, but also smart devices such as smartphones or tablets, which in their camera systems have a silicon-based image sensor that can detect incident photons up to a wavelength of approx. 1100 nm. These smart devices can also be used via the camera flash for excitation of the photoluminescent materials.

A consultation is ordinarily carried out on the precision of the imaging method in order to achieve comparable extraction for all steps.

For this purpose, minimum standards for the accuracy of the imaging method are preferably established that must be met by all devices used in the methods according to the invention for unique marking of products/documents and for identifying products/documents as described herein.

The control of the flash for excitation and detection can be carried out via a corresponding app so that after excitation and detection, for example, a corresponding photo of the attached flat element appears on the screen of the smart device.

The production inaccuracies extracted from the attached flat element comprise all types of production inaccuracies, i.e. unintentional and intrinsic deviations in the surface of the product, document and/or substrate itself, unintentional and intrinsic deviations in the printed-on printing composition and unintentional and intrinsic deviations in the print image of the identification pattern printed on with the printing composition as described above.

The unintentional and intrinsic deviations in the surface of the product, document and/or substrate are the result of random, uncontrollable processes during the production of the product, document and/or substrate itself. In the method according to the invention, these production inaccuracies, in the preferred process step of printing of the printing composition onto at least one flat element of the surface of the product, are expanded to include the deviations in the printed-on printing composition or deviations in the print image of the identification pattern printed on with the printing composition. These unintentional and intrinsic deviations are the result of random, uncontrollable processes during the process step of printing of the printing composition onto at least one flat element of the surface of the product and depend on the individual printing composition and the individual printer.

These production inaccuracies are therefore well-suited for individualization of a product from a plurality of identical products.

The special use of printing composition comprising one or more photoluminescent materials, which emit radiation under photon excitation in the range of up to 3000 nm, preferably up to 1800 nm, more preferably up to 1400 nm, and most preferably up to 1100 nm, and which preferably comprise one or more semiconducting inorganic nanocrystals that emit radiation under photon excitation in the range of 750 to 1800 nm, preferably from 800 to 1400 nm, and most preferably from 850 nm to 1100 nm, expands the identification spectrum of the production inaccuracies to be extracted by the spectral range of up to 3000 nm, preferably by the spectral range of NIR irradiation up to 1800 nm, more preferably up to 1400 nm, and most preferably up to 1100 nm. It is therefore possible in detection of all production inaccuracies from the attached flat element in the spectral range of up to 3000 nm, preferably up to 1800 nm, more preferably up to 1400 nm, and most preferably up to 1100 nm to extract an extremely high density of production inaccuracies per attached flat element. The minimum size of the attached flat element can thus be kept extremely small.

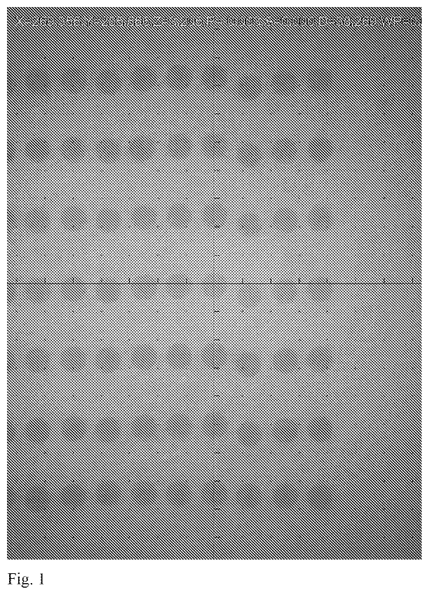

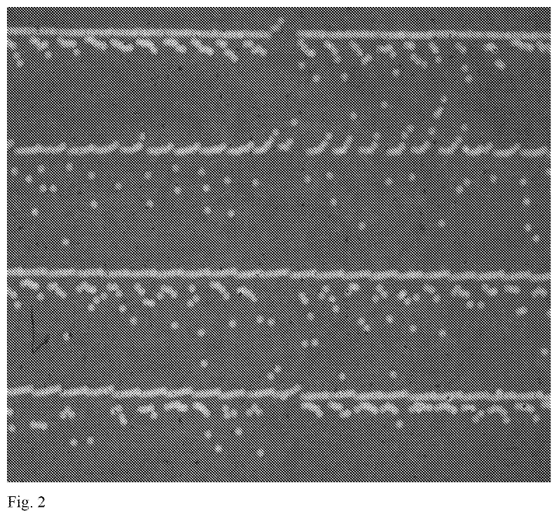

From a superficial standpoint, the attached flat element, and particularly the print(out), ordinarily show no production inaccuracies. However, in observation on the micron scale, an individual pattern is normally recognizable. In ink-jet printing, this can arise for example due to clogging of the printing nozzles, partial clogging of the printing nozzles, deviation of the ink drops or delayed deposition of the ink drops from the printing nozzle. This gives rise to a random pattern on the micron level that is unique for each printing process. This is shown as an example in FIGS. 1 and 2. Together with the random and unique patterns of the other above-mentioned production inaccuracies, this unique pattern can be assigned to an individual product as a unique total pattern by means of IT applications, and can be stored. From this unique total pattern, a unique code can also be extracted as described above, which can also be stored in encrypted form on a storage medium, for example a database.

In order to ensure true individualisation, depending on the number of the entities of a product to be individualised, a corresponding number of production inaccuracies are to be identified and assigned to the individual entity. Statistically, as one can only expect in each attached flat element a certain number of production inaccuracies per square centimetre of the attached flat element respectively, the number of individualizable entities is dependent on the area of the attached flat element.

In the present invention, it was possible to increase the number of production inaccuracies per area of the attached flat element by expanding the selection of production inaccuracies to include production inaccuracies that are to be detected in the spectral range of up to 3000 nm, in particular to include deviations in the printed-on printing composition or deviations in the print image of the identification pattern printed on with the printing composition, and to expand the detection spectrum, made possible by the printing composition used, of emissions in the visible light range (380 to 750 nm) of the usual commercial photoluminescent materials to include emissions in the visible light and longer-wavelength spectral range of up to 3000 nm, especially in the near infrared range (up to 1800 nm, preferably up to 1400 nm, and most preferably up to 1100 nm).

Because of the higher density of production inaccuracies per area of the flat element, the increase in the number of production inaccuracies per area of the attached flat element allows a reduction in the area of the attached flat element in the range in which the attached flat element can be read out and stored by simple electronic and mobile smart devices, for example smartphones and tablets, but also spectrometers, NIR cameras or industrial cameras using corresponding software.

Therefore, an attached flat element with a maximum size of 10 cm² can be sufficient even for the identification of individual entities from a product quantity in the range of several million.

For example, for the identification of individual entities from a product quantity in the range of over 100 million, an attached flat element with a maximum size of 10 cm² can be sufficient.

For the identification of individual entities from a product quantity in the range of up to 10 million, an attached flat element with a maximum size of 7 cm² can be sufficient.

For the identification of individual entities from a product quantity in the range of up to 1 million, an attached flat element with a maximum size of 5 cm² can be sufficient.

For the identification of individual entities from a product quantity in the range of up to 100,000, an attached flat element with a maximum size of 3 cm² can be sufficient.

In the prior art, a flat element of over 10 cm² in minimum size has been required in order to extract sufficient production inaccuracies for the individualisation of 100 million entities.

All of the production inaccuracies detected with the electronic device used should preferably be extracted.

It is also in accordance with the method if only a part of the production inaccuracies detected by the electronic device used is extracted.

Ordinarily, the identified production inaccuracies are then partially or completely stored, ordinarily in a storage medium such as a database.

### Identification of the Marked Product:

In a further aspect, the present invention relates to a method for identifying products/documents that have been marked by the method for unique marking as described herein, wherein the method comprises the following steps:
irradiating the attached flat element with photons;
extraction of production inaccuracies from the attached flat element in the spectral range of up to 3000 nm, preferably up to 1800 nm, more preferably up to 1400 nm, and most preferably up to 1100 nm;
correlating of the extracted production inaccuracies with the stored production inaccuracies.

The attached flat element is irradiated with photons, preferably with white or blue light, and preferably white or blue LED light.

An example of a light source is a halogen lamp or LED lamp, preferably a blue or shite LED lamp. Another suitable light source for the irradiation is an LED flash, such as e.g. the LED flash of a terminal device, such as e.g. a smartphone or tablet.

In a specific embodiment, the photons may also comprise shorter-wavelength light such as UV light. A suitable light source for this embodiment is a UV lamp.

After irradiation, the attached flat element, preferably the photoluminescent materials in the printing composition of the printed-on identification pattern, emits radiation in the range of up to 3000 nm, preferably up to 1800 nm, more preferably up to 1400 nm, and most preferably up to 1100 nm, more preferably the semiconducting inorganic nanocrystals in the printing composition of the printed-on identification pattern emit radiation in the range of 750 to 1800 nm, preferably from 800 to 1400 nm, and most preferably from 850 nm to 1100 nm.

Irradiation in the range from 750 nm, for example from 750 nm to 1800 nm (NIR irradiation), cannot be perceived by the unaided human eye. Instead, an electronic device is required for detection that can detect the emitted irradiation over the entire range of up to 3000 nm, for example from 750 to 1800 nm, preferably from 800 to 1400 nm, and most preferably from 850 nm to 1100 nm.

For example, suitable devices are spectrometers, industrial cameras, NIR cameras, but also smart devices such as smartphones or tablets, which in their camera systems have a silicon-based image sensor that can detect incident photons up to a wavelength of approx. 1100 nm. These smart devices can also be used for excitation of the photoluminescent materials via the camera flash/LED.

The control of the flash/LED for excitation and detection can be carried out via a corresponding app, so that after excitation and detection, for example, a corresponding photo of the attached flat element appears on the screen of the smart device.

The attached flat element is examined for production inaccuracies in the spectral range of up to 3000 nm, preferably up to 1800 nm, more preferably up to 1400 nm, and most preferably 1100 nm. These production inaccuracies are extracted from the attached flat element.

The lower end of the range is ordinarily at 380 nm, preferably at 390 nm, and most preferably at 400 nm.

As not all of the irradiation range lies in the visible light range, an electronic device is also required for this step that can detect the emitted irradiation over the entire spectral range of up to 3000 nm, preferably up to 1800 nm, more preferably up to 1400 nm, and most preferably up to 1100 nm. The lower end of the spectral range is ordinarily at 380 nm, preferably at 390 nm, and most preferably at 400 nm.

For example, suitable devices would be spectrometers, industrial cameras, NIR cameras, but also smart devices such as smartphones or tablets, which in their camera systems have a silicon-based image sensor that can detect incident photons up to a wavelength of approx. 1100 nm. However, detection can be carried out using corresponding software, for example an app.

It is preferred for the irradiation of the attached flat element with photons and the extraction of production inaccuracies from the attached flat element to apply the same steps and standards as described above for the extraction of production inaccuracies from the attached flat element during marking of the products/documents.

For this purpose—as described above—minimum standards for the accuracy of the imaging method are preferably established that must be met by all devices used in the methods according to the invention for unique marking of products/documents and for identifying products/documents as described herein.

For example, irradiation of the attached flat element is carried out with photons and the extraction of production inaccuracies from the attached flat element is preferably carried out with the same electronic device and corresponding software, such as e.g. an electronic smart device, such as e.g. a smartphone or tablet with suitable software, for example an app.

In a special embodiment, production inaccuracies from the attached flat element can be extracted in a spectral range of at least 200 nm, preferably at least 225 nm, more preferably at least 250 nm as a lower limit. Special electronic detectors, such as e.g. UV detectors, are required for this purpose.

The production inaccuracies extracted from the attached flat element comprise all types of production inaccuracies, i.e. unintended and intrinsic deviations in the surface of the product, document and/or substrate itself, unintentional and intrinsic deviations in the printed-on printing composition or unintentional and intrinsic deviations in the print image of the identification pattern printed on with the printing composition as described above.

All of the production inaccuracies detected with the electronic device used are preferably extracted, and in the next step, correlated with the stored production inaccuracies.

It is also in accordance with the method if only a part identification of the production inaccuracies detected with the electronic device used is extracted and correlated in the next step with the stored production inaccuracies.

The extracted production inaccuracies are then correlated with the stored production inaccuracies and assigned to an individual product.

With the method according to the invention, an identity from a number of products/documents can be uniquely assigned. By means of possible additional encryption with a secure key, for example in the form of a unique code as described above, the unique marking can be made additionally secure.

It is unique because an individual pattern of production inaccuracies can be assigned to each entity that was not generated by copiable random processes during the production of the product and printing of the identification pattern. The production inaccuracies therefore serve, as a physically unclonable function (PUF), as a second factor for a secure identity.

The method according to the invention is therefore suitable for generating a physically unclonable function (PUF) of a secure and unique identity of products and can therefore be used together with encryption in serialisation systems, track and trace applications or for document authentication.

The invention also relates to a product with an optical security feature for unique marking and identification, preferably for unique and secure marking and identification, of products on at least one flat element of the surface of the product, wherein the security feature comprises an attached flat element, wherein the attached flat element comprises production inaccuracies that are preferably extracted in the range of up to identification 3000 nm, preferably up to 1800 nm, more preferably up to 1400 nm, and most preferably up to 1100 nm.

The optical security feature is preferably applied to the product by the method according to the invention described herein and used for the marking and identification of the individual product.

The invention further relates to use of the optical security feature as described herein as a unique identity, preferably as a unique and secure identity, for product authentication and/or for document authentication.

The invention also relates to a serialisation and/or track and trace system that comprises an optical security feature as described herein.

Finally, the invention relates to use of an optical security feature as described herein in a serialisation and/or track and trace system and/or for document authentication.

The features of methods according to the invention described herein, the identification pattern, the printing compositions, the photoluminescent materials that attached flat element and the production inaccuracies are also to be applied to the optical security feature according to the invention, the serialisation and/or track and trace system according to the invention, and to the uses according to the invention.

1. A method for unique marking of products/documents, comprising:
attaching a flat element to at least one surface of the product;
irradiating the attached flat element with photons;
extraction of production inaccuracies from the attached flat element in the spectral range of up to 3000 nm;
storage of the production inaccuracies extracted from the attached flat element.

2. The method according to claim 1, wherein the attached flat element comprises photoluminescent materials which emit radiation under photon excitation in the range of up to 3000 nm.

3. The method according to claim 2, wherein the photoluminescent materials comprise semiconducting inorganic nanocrystals.

4. The method according to claim 3, wherein the semiconducting inorganic nanocrystals are selected from the group of the perovskites, I-VI semiconductors, II-VI semiconductors, III-V semiconductors, IV-VI semiconductors, I-III-VI semiconductors, carbon dots and mixtures thereof.

5. The method according to claim 2, wherein the photoluminescent materials are comprised in a printing composition and the printing composition is printed onto at least one surface of the product.

6. The method according to claim 5, wherein the printing composition is printed in the form of an identification pattern onto at least one surface of the product.

7. The method according to claim 6, wherein the identification pattern is unique for each individual product.

8. The method according to claim 6, wherein the identification pattern comprises a unique code and the method serves for unique and secure marking and identification of products.

9. The method according to claim 6, wherein the identification pattern is one or two dimensional, preferably one-dimensional, two-dimensional or three-dimensional.

10. The method according to claim 6, wherein the identification pattern comprises one or more patterns, wherein the one or more patterns comprise flat elements, stripes, lines, geometric figures alphanumeric characters, characters or combinations thereof, wherein the geometric figures comprise circles, triangles, rectangles, or polygons.

11. The method according to claim 6, wherein the attached flat element overlaps with the flat element of the printed identification pattern in the range of 10% to 100%.

12. The method according to claim 1, wherein the production inaccuracies comprise deviations in the surface of the product, document and/or substrate itself, deviations in a printed-on printing composition and deviations in the print image of an identification pattern printed on with the printing composition.

13. A method for identifying products/documents that were marked with the method for unique marking according to claim 1, wherein the method comprises:
irradiating the attached flat element with photons;
extraction of production inaccuracies from the attached flat element in the range of up to 3000 nm;
correlating of the extracted production inaccuracies with the stored production inaccuracies.

14. The method according to claim 13, wherein the attached flat element is irradiated for excitation with blue or white light.

15. The method according to claim 13, wherein an electronic smart device is used for irradiation, wherein the smart device comprises a smartphone, a tablet, a spectrometer, or an industrial camera.

16. The method according to claim 13, wherein for extraction of the production inaccuracies and storage of the extracted production inaccuracies and/or for extraction of the production inaccuracies and correlating of the extracted production inaccuracies with the stored production inaccuracies, an electronic smart device with suitable software is used, wherein the electronic smart device comprises a smartphone or a tablet and the suitable software comprises an app.

17. A product with an optical security feature for unique marking and identification of products onto at least one flat element of the surface of the product, wherein the security feature comprises an attached flat element, wherein the attached flat element comprises production inaccuracies that are extracted in the range of up to 3000 nm.

18. (canceled)

19. A serialisation and/or track and trace system, comprising the optical security feature according to claim 17.

20. (canceled)
